(19) United States
(12) Patent Application Publication
(10) Pub. No.: US 2026/0176073 A1
(43) Pub. Date: Jun. 25, 2026

(54) DETECTING A MOVING PICKING STATION ON A GRID

(71) Applicant: Ocado Innovation Limited, Hatfield (GB)

(72) Inventors: Davide LORA, London (GB); David SOBEY, London (GB); Herne HOLLAMBY, London (GB); Matas SRIUBISKIS, Toronto (CA)

(21) Appl. No.: 19/132,709

(22) PCT Filed: Nov. 30, 2023
(86) PCT No.: PCT/EP2023/083779

§ 371 Date: May 23, 2025

(30) Foreign Application Priority Data
Nov. 30, 2022 (GB) 2218001.2

(51) Int. Cl. B65G 1/137; G05D 1/249; G05D 107/70; G06V 10/82; G06V 20/70

(52) U.S. Cl. CPC B65G 1/1375; G05D 1/249; G06V 10/82; G06V 20/70; G05D 2107/70

(57) ABSTRACT

Detecting a Moving Picking Station on a Grid A detection system and method for detecting a moving picking station on a grid, comprising a plurality of grid cells, forming part of a grid-based storage system in which one or more picking stations are mounted on the grid. Each picking station comprising a robotic manipulator to transfer items between containers received in respective grid cells adjacent the picking station. The method involves obtaining image data representative of a series of images of at least part of the grid. The image data is processed with an object detection model trained to detect instances of picking stations on the grid and it is determined, based on the processing, whether the series of images includes a moving picking station of the one or more picking stations. In response to determining that the image includes the moving picking station, annotation data indicative of the moving picking station in the image is outputted.

### TECHNICAL FIELD

The present disclosure generally relates to the field of grid-based storage systems, and more specifically to detecting a moving picking station on a grid forming part of a grid-based storage system.

### BACKGROUND

Online retail businesses selling multiple product lines, such as online grocers and supermarkets, require systems that can store tens or hundreds of thousands of different product lines. The use of single-product stacks in such cases can be impractical since a vast floor area would be required to accommodate all of the stacks required. Furthermore, it can be desirable to store small quantities of some items, such as perishables or infrequently ordered goods, making single-product stacks an inefficient solution.

PCT Publication No. WO2015/185628A (Ocado) describes a further known storage and fulfilment system in which stacks of containers are arranged within a grid framework structure. The containers are accessed by one or more load handling devices, otherwise known as robots or “bots”, operative on tracks located on the top of the grid framework structure. A system of this type is illustrated schematically in FIGS. 1 to 3 of the accompanying drawings.

As shown in FIGS. 1 and 2, stackable containers 10, also known as “bins”, are stacked on top of one another to form stacks 12. The stacks 12 are arranged in a grid framework structure 14, e.g. in a warehousing or manufacturing environment. The grid framework structure 14 is made up of a plurality of storage columns or grid columns. Each grid in the grid framework structure has at least one grid column to store a stack of containers. FIG. 1 is a schematic perspective view of the grid framework structure 14, and FIG. 2 is a schematic top-down view showing a stack 12 of bins 10 arranged within the framework structure 14. Each bin 10 typically holds a plurality of product items (not shown). The product items within a bin 10 may be identical or different product types depending on the application.

The grid framework structure 14 comprises a plurality of upright members 16 that support horizontal members 18, 20. A first set of parallel horizontal grid members 18 is arranged perpendicularly to a second set of parallel horizontal members 20 in a grid pattern to form a horizontal grid structure 15 supported by the upright members 16. The members 16, 18, 20 are typically manufactured from metal. The bins 10 are stacked between the members 16, 18, 20 of the grid framework structure 14, so that the grid framework structure 14 guards against horizontal movement of the stacks 12 of bins 10 and guides the vertical movement of the bins 10.

The top level of the grid framework structure 14 comprises a grid or grid structure 15, including rails 22 arranged in a grid pattern across the top of the stacks 12. Referring to FIG. 3, the rails or tracks 22 guide a plurality of load handling devices 30. A first set 22a of parallel tracks or rails 22 guides movement of the robotic load handling devices 30 in a first direction (e.g. an X-direction) across the top of the grid framework structure 14. A second set 22b of parallel tracks or rails 22, arranged perpendicular to the first set 22a, guides movement of the load handling devices 30 in a second direction (e.g. a Y-direction), perpendicular to the first direction. In this way, the tracks or rails 22 allow the robotic load handling devices 30 to move laterally in two dimensions in the horizontal X-Y plane. A load handling device 30 can be moved into position above any of the stacks 12.

A known form of load handling device 30—shown in FIGS. 4 and 5—is described in PCT Patent Publication No. WO2015/019055 (Ocado), hereby incorporated by reference, where each load handling device 30 covers a single grid space 17 of the grid framework structure 14. This arrangement allows a higher density of load handlers and thus a higher throughput for a given sized storage system.

The example load handling device 30 comprises a vehicle 32, which is arranged to travel on the rails 22 of the frame structure 14. A first set of wheels 34, consisting of a pair of wheels 34 at the front of the vehicle 32 and a pair of wheels 34 at the back of the vehicle 32, is arranged to engage with two adjacent rails of the first set 22a of rails 22. Similarly, a second set of wheels 36, consisting of a pair of wheels 36 at each side of the vehicle 32, is arranged to engage with two adjacent rails of the second set 22b of rails 22. Each set of wheels 34, 36 can be lifted and lowered so that either the first set of wheels 34 or the second set of wheels 36 is engaged with the respective set of rails 22a, 22b at any one time during movement of the load handling device 30. For example, when the first set of wheels 34 is engaged with the first set of rails 22a and the second set of wheels 36 is lifted clear from the rails 22, the first set of wheels 34 can be driven, by way of a drive mechanism (not shown) housed in the vehicle 32, to move the load handling device 30 in the X-direction. To achieve movement in the Y-direction, the first set of wheels 34 is lifted clear of the rails 22, and the second set of wheels 36 is lowered into engagement with the second set 22b of rails 22. The drive mechanism can then be used to drive the second set of wheels 36 to move the load handling device 30 in the Y-direction.

The load handling device 30 is equipped with a lifting mechanism, e.g. a crane mechanism, to lift a storage container from above. The lifting mechanism comprises a winch tether or cable 38 wound on a spool or reel (not shown) and a gripper device 39. The lifting mechanism shown in FIGS. 4 and 5 comprises a set of four lifting tethers 38 extending in a vertical direction. The tethers 38 are connected at or near the respective four corners of the gripper device 39, e.g. a lifting frame, for releasable connection to a storage container 10. For example, a respective tether 38 is arranged at or near each of the four corners of the lifting frame 39. The gripper device 39 is configured to releasably grip the top of a storage container 10 to lift it from a stack of containers in a storage system 1 of the type shown in FIGS. 1 and 2. For example, the lifting frame 39 may include pins (not shown) that mate with corresponding holes (not shown) in the rim that forms the top surface of bin 10, and sliding clips (not shown) that are engageable with the rim to grip the bin 10. The clips are driven to engage with the bin 10 by a suitable drive mechanism housed within the lifting frame 39, powered and controlled by signals carried through the cables 38 themselves or a separate control cable (not shown).

To remove a bin 10 from the top of a stack 12, the load handling device 30 is first moved in the X- and Y-directions to position the gripper device 39 above the stack 12. The gripper device 39 is then lowered vertically in the Z-direction to engage with the bin 10 on the top of the stack 12, as shown in FIGS. 4 and 6B. The gripper device 39 grips the bin 10, and is then pulled upwards by the cables 38, with the bin 10 attached. At the top of its vertical travel, the bin 10 is held above the rails 22 accommodated within the vehicle body 32. In this way, the load handling device 30 can be moved to a different position in the X-Y plane, carrying the bin 10 along with it, to transport the bin 10 to another location. On reaching the target location (e.g. another stack 12, an access point in the storage system, or a conveyor belt) the bin or container 10 can be lowered from the container receiving portion and released from the grabber device 39. The cables 38 are long enough to allow the load handling device 30 to retrieve and place bins from any level of a stack 12, e.g. including the floor level.

As shown in FIG. 3, a plurality of load handling devices 30 is provided so that each load handling device 30 can operate simultaneously to increase the system's throughput. The system illustrated in FIG. 3 may include specific locations, known as ports, at which bins 10 can be transferred into or out of the system. An additional conveyor system (not shown) is associated with each port so that bins 10 transported to a port by a load handling device 30 can be transferred to another location by the conveyor system, such as a picking station (not shown). Similarly, bins 10 can be moved by the conveyor system to a port from an external location, for example, to a bin-filling station (not shown), and transported to a stack 12 by the load handling devices 30 to replenish the stock in the system.

Each load handling device 30 can lift and move one bin 10 at a time. The load handling device 30 has a container-receiving cavity or recess 40, in its lower part. The recess 40 is sized to accommodate the container 10 when lifted by the lifting mechanism 38, 39, as shown in FIGS. 6A and 6B. When in the recess, the container 10 is lifted clear of the rails 22 beneath, so that the vehicle 32 can move laterally to a different grid location.

If it is necessary to retrieve a bin 10b (“target bin”) that is not located on the top of a stack 12, then the overlying bins 10a (“non-target bins”) must first be moved to allow access to the target bin 10b. This is achieved by an operation referred to hereafter as “digging”. Referring to FIG. 3, during a digging operation, one of the load handling devices 30 lifts each non-target bin 10a sequentially from the stack 12 containing the target bin 10b and places it in a vacant position within another stack 12. The target bin 10b can then be accessed by the load handling device 30 and moved to a port for further transportation.

Each load handling device 30 is remotely operable under the control of a central computer, e.g. a master controller. Each individual bin 10 in the system is also tracked so that the appropriate bins 10 can be retrieved, transported and replaced as necessary. For example, during a digging operation, each non-target bin location is logged so that the non-target bin 10a can be tracked.

Wireless communications and networks may be used to provide the communication infrastructure from the master controller, e.g. via one or more base stations, to one or more load handling devices 30 operative on the grid structure 15. In response to receiving instructions from the master controller, a controller in the load handling device 30 is configured to control various driving mechanisms to control the movement of the load handling device. For example, the load handling device 30 may be instructed to retrieve a container from a target storage column at a particular location on the grid structure 15. The instruction can include various movements in the X-Y plane of the grid structure 15. As previously described, once at the target storage column, the lifting mechanism 38, 39 can be operated to grip and lift the storage container 10. Once the container 10 is accommodated in the container-receiving space 40 of the load handling device 30, it is subsequently transported to another location on the grid structure 15, e.g. a “drop-off port”. At the drop-off port, the container 10 is lowered to a suitable pick station to allow retrieval of any item in the storage container. Movement of the load handling devices 30 on the grid structure 15 can also involve the load handling devices 30 being instructed to move to a charging station, usually located at the periphery of the grid structure 15.

To manoeuvre the load handling devices 30 on the grid structure 15, each of the load handling devices 30 is equipped with motors for driving the wheels 34, 36. The wheels 34, 36 may be driven via one or more belts connected to the wheels or driven individually by a motor integrated into the wheels. For a single-cell load handling device (where the footprint of the load handling device 30 occupies a single grid cell 17), and the motors for driving the wheels can be integrated into the wheels due to the limited availability of space within the vehicle body. For example, the wheels of a single-cell load handling device 30 are driven by respective hub motors. Each hub motor comprises an outer rotor with a plurality of permanent magnets arranged to rotate about a wheel hub comprising coils forming an inner stator.

The system described with reference to FIGS. 1 to 5 has many advantages and is suitable for a wide range of storage and retrieval operations. In particular, it allows very dense storage of products and provides a very economical way of storing a wide range of different items in the bins 10 while also allowing reasonably economical access to all of the bins 10 when required for picking.

With reference to FIG. 6, the system may further comprise a robotic picking station 50 mounted on top of the storage and retrieval structure 1, e.g. alongside the load-handling devices 30 (not shown). The robotic picking station 50 comprises a robotic manipulator 52 comprising a robotic arm 54 and an end effector 56 for releasably engaging a product to be manipulated, together with several designated grid cells 60, 62. The end effector 56 may be a suction device 64 connected to a vacuum source by a vacuum line 66. The robotic manipulator 52 is mounted on a plinth 58 above a single grid cell 60 and, depending on its location on the structure 1, can be surrounded by up to eight other grid cells 62 as shown in FIG. 6. In general, the robotic manipulator 52 is configured to pick an item or product from any one of the containers located in one of the designated grid cells 62 and place it in a container located in another of the designated grid cells 62. The load-handling devices collect containers from, and deliver them to, the designated grid cells 62 as necessary. In this way, the robotic picking station 50 and the load-handling devices 30 work in conjunction to fulfil a customer order or redistribute products throughout the storage and retrieval system 1.

### SUMMARY

There is provided a computer-implemented method of detecting a moving picking station on a grid comprising a plurality of grid cells, the grid forming part of a grid-based storage system in which one or more picking stations are mounted on the grid, each picking station comprising a robotic manipulator to transfer items between containers received in respective grid cells adjacent the picking station, the method comprising: obtaining image data representative of a series of images of at least part of the grid; processing the image data with an object detection model trained to detect instances of picking stations on the grid; determining, based on the processing, whether the series of images includes a moving picking station of the one or more picking stations; and in response to determining that the image includes the moving picking station, outputting annotation data indicative of the moving picking station in the image.

Further provided is a data processing apparatus comprising a processor configured to perform the method. Also provided is a computer program comprising instructions which, when the program is executed by a computer, cause the computer to carry out the method. Similarly, a computer-readable storage medium is provided which comprises instructions that, when executed by a computer, cause the computer to carry out the method.

Further provided is a detection system to detect a moving picking station on a grid comprising a plurality of grid cells, the grid forming part of a grid-based storage system in which one or more picking stations are mounted on the grid, each picking station comprising a robotic manipulator to transfer items between containers received in respective grid cells adjacent the picking station, the detection system comprising: an image sensor to capture a series of images of at least part of the grid; an object detection model trained to detect instances of moving picking stations on the grid; wherein the detection system is configured to: obtain image data representative of the series of images; process the image data with the object detection model; determine, based on the processing, whether the series of images includes a moving picking station of the one or more picking stations; and in response to determining that the image includes the moving picking station, output annotation data indicative of the moving picking station in the image.

In general terms, this description introduces systems and methods to detect moving robotic pick stations installed on the grid of a grid-based automated storage and retrieval system (ASRS) so that the moving pick station can be distinguished from other, e.g. non-moving, pick stations on the grid. The systems and methods allow for a check that the correct robotic pick station is moving on the grid, e.g. in accordance with a set of scheduled movements as part of a maintenance operation. For example, during an inspection of a given pick station in which one or more persons are present on the grid with the pick stations, the systems and methods can be implemented to check whether or not a different nearby pick station is moving, thereby providing an extra layer of safety when humans are in the vicinity of the robotic pick stations on the grid.

### BRIEF DESCRIPTION OF THE DRAWINGS

Embodiments will now be described by way of example only with reference to the accompanying drawings, in which like reference numbers designate the same or corresponding parts, and in which:

FIG. 1 shows a schematic depiction of an automated storage and retrieval structure;

FIG. 2 shows a schematic depiction of a plan view of a section of track structure forming part of the storage structure of FIG. 1;

FIG. 3 shows a schematic depiction of a plurality of load-handling devices moving on top of the storage structure of FIG. 1;

FIGS. 4 and 5 show a schematic depiction of a load-handling device interacting with a container;

FIG. 6 shows a schematic depiction of a known robotic picking station;

FIGS. 7A and 7B are schematic diagrams of a storage system with a camera positioned above the grid framework structure as part of a detection system according to embodiments;

FIG. 8 is a schematic representation of an image captured by the camera positioned above the grid framework structure according to a specific embodiment;

FIG. 9 is a schematic diagram of a neural network;

FIGS. 10A and 10B are schematic diagrams of a generated model of the tracks of the grid framework structure;

FIG. 11 is a schematic diagram showing a flattening of a captured image of the grid framework structure;

FIG. 12 is a schematic diagram demonstrating the processing of a captured image of the grid framework structure according to embodiments;

FIG. 13 shows a flowchart depicting a method of detecting a moving picking station on a grid forming part of a grid-based storage system according to embodiments; and

FIG. 14 shows a flowchart depicting a method of detecting an identification marker on a picking station located on the grid according to embodiments.

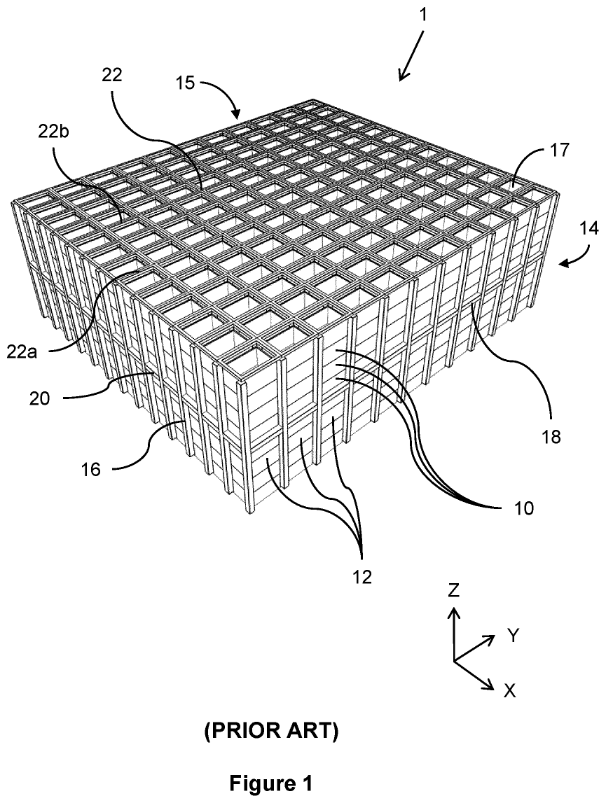

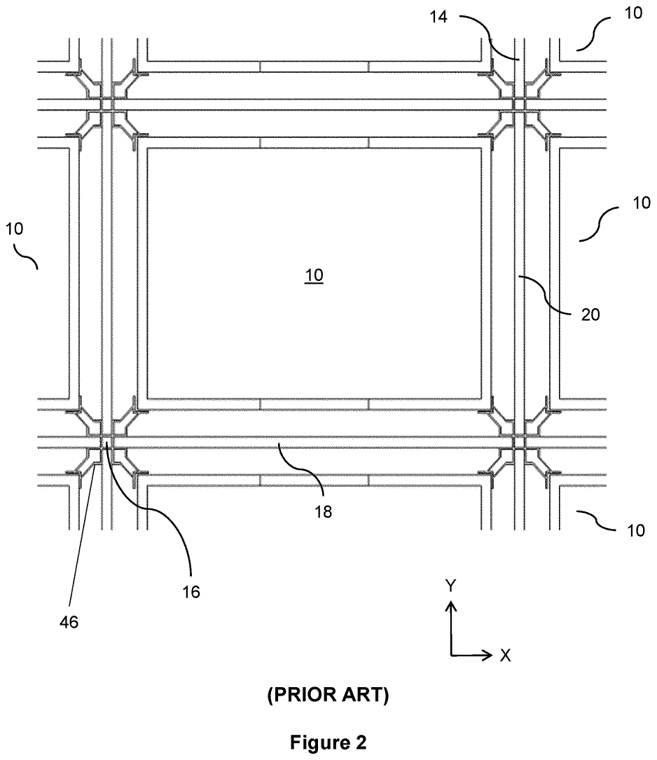

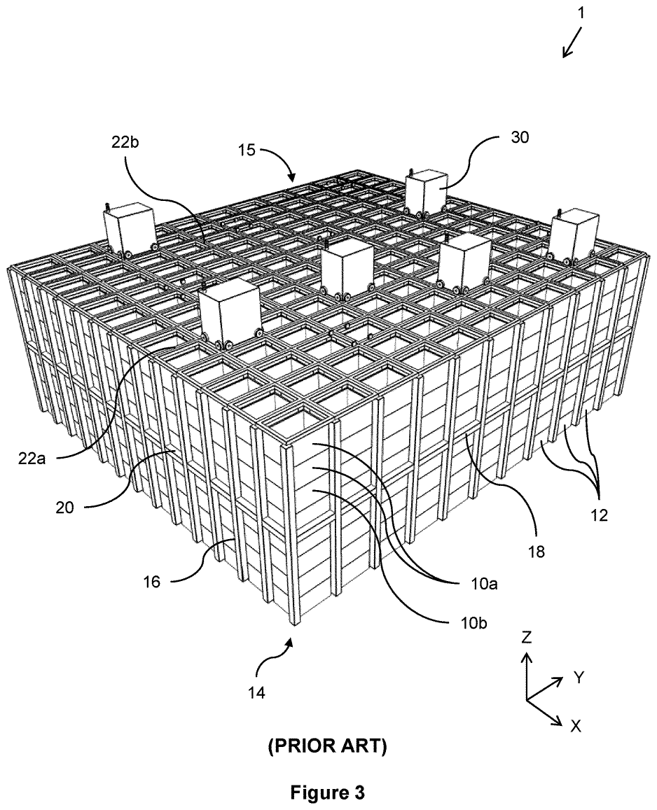

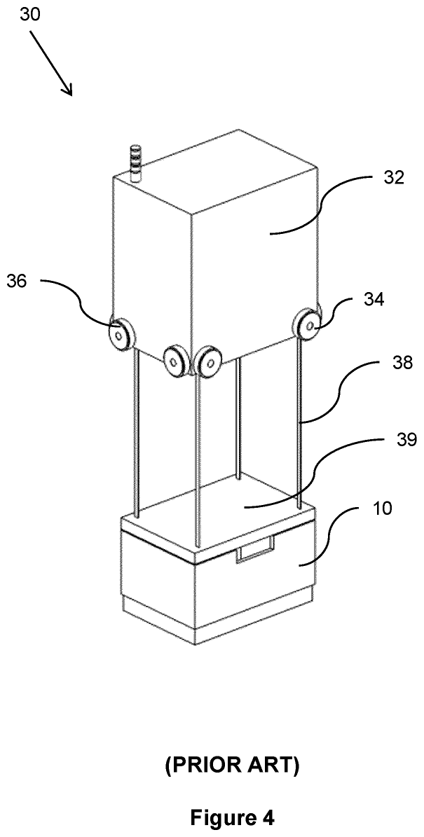

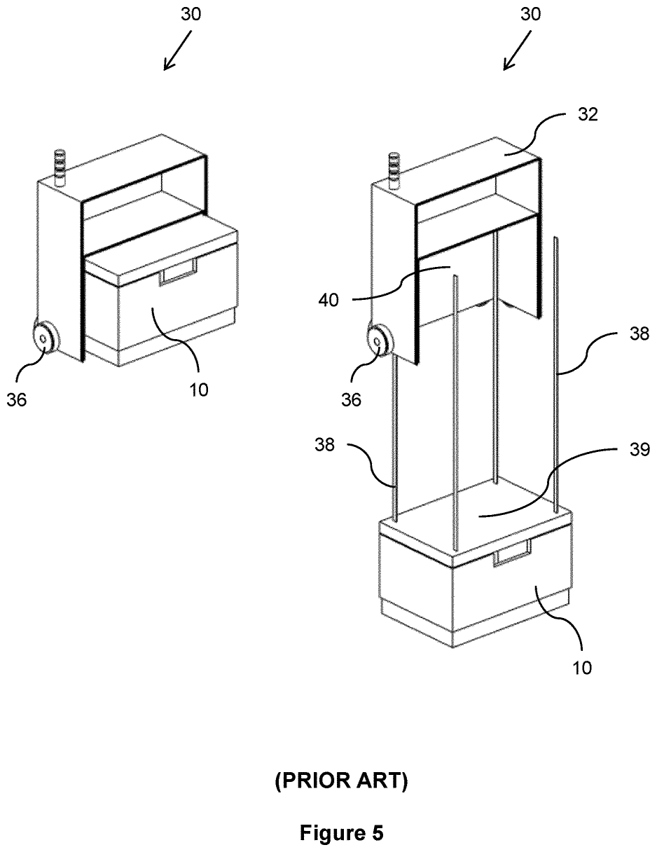

### DETAILED DESCRIPTION

In the following description, some specific details are included to provide a thorough understanding of the disclosed examples. One skilled in the relevant art, however, will recognise that other examples may be practised without one or more of these specific details, or with other components, materials, etc., and structural changes may be made without departing from the scope of the invention as defined in the appended claims. Moreover, references in the following description to any terms having an implied orientation are not intended to be limiting and refer only to the orientation of the features as shown in the accompanying drawings. In some instances, well-known features or systems, such as processors, sensors, storage devices, network interfaces, fasteners, electrical connectors, and the like are not shown or described in detail to avoid unnecessarily obscuring descriptions of the disclosed embodiment.

Unless the context requires otherwise, throughout the specification and the appended claims, the word “comprise” and variations thereof, such as, “comprises” and “comprising” are to be construed in an open, inclusive sense that is as “including, but not limited to.”

Reference throughout this specification to “one”, “an”, or “another” applied to “embodiment”, “example”, means that a particular referent feature, structure, or characteristic described in connection with the embodiment, example, or implementation is included in at least one embodiment, example, or implementation. Thus, the appearances of the phrase “in one embodiment” or the like in various places throughout this specification are not necessarily all referring to the same embodiment. Furthermore, the particular features, structures, or characteristics may be combined in any suitable manner in one or more embodiments, examples, or implementations.

It should be noted that, as used in this specification and the appended claims, the users forms “a”, “an”, and “the” include plural referents unless the content clearly dictates otherwise. It should also be noted that the term “or” is generally employed in its sense including “and/or” unless the content clearly dictates otherwise.

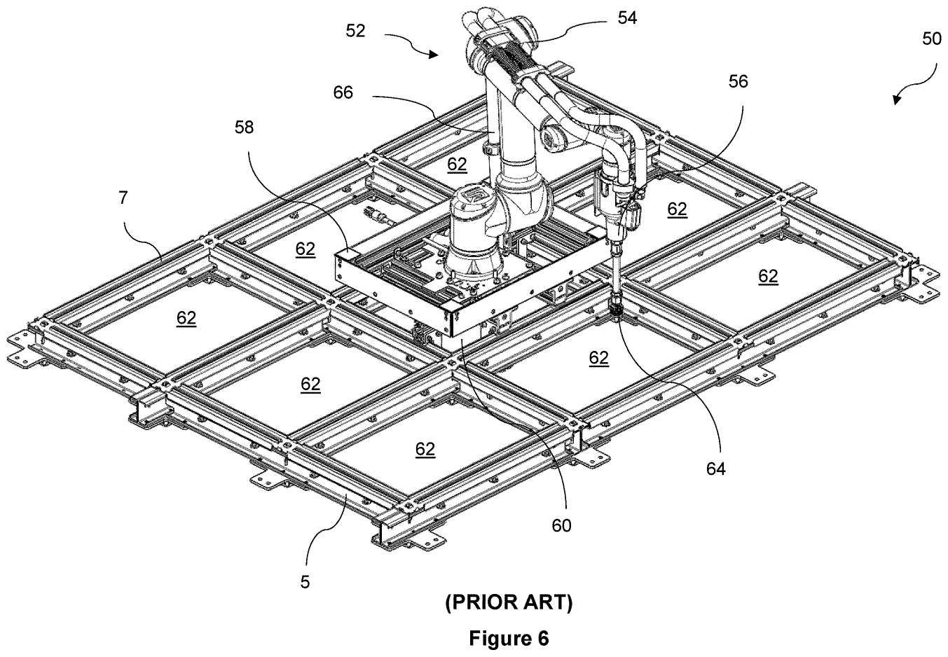

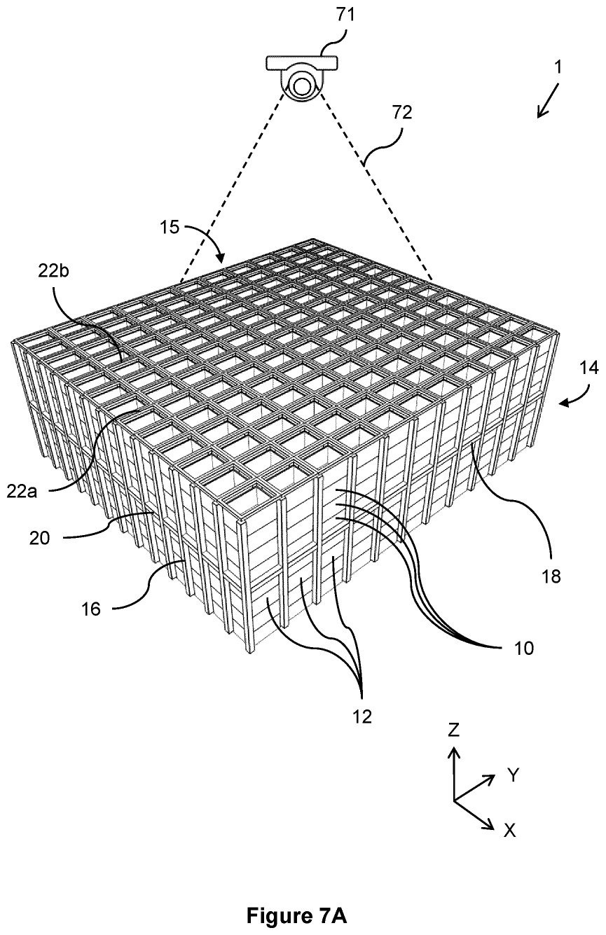

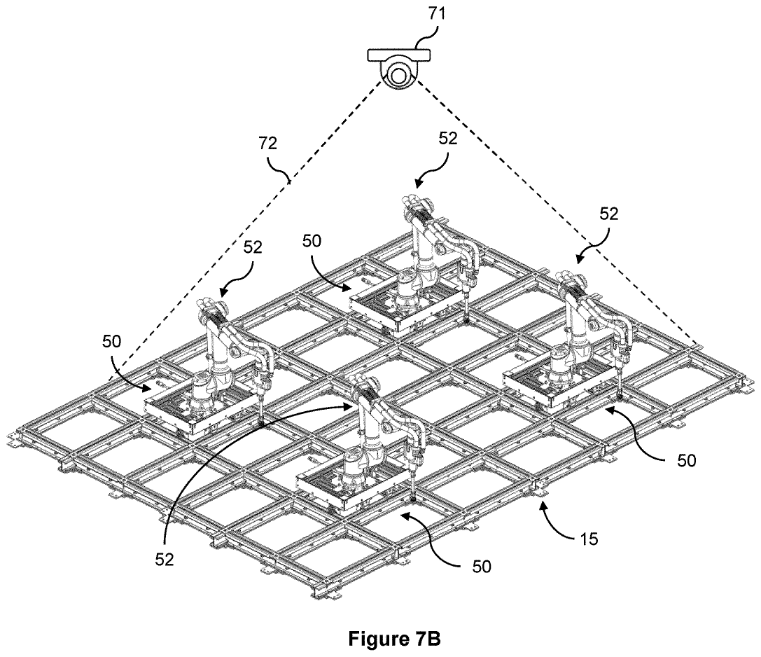

FIGS. 7A and 7B show a schematic depiction of a detection system to detect a moving picking station 50 on a grid 15 forming part of a grid-based storage system 1 according to an embodiment. The grid-based storage system 1 is of the type previously described, e.g. an automated storage and retrieval system (or “ASRS”). In this embodiment, there are multiple robotic picking stations 50 mounted on top of the grid-based storage system 1, e.g. mounted on the grid structure (or simply “grid”) 15 as previously described with reference to FIG. 6. Each picking station 50 comprises a robotic manipulator 52 to transfer items between containers received in designated grid cells adjacent to the respective picking station 50. For example, the robotic manipulator 52 includes an end effector for releasably engaging the items to be manipulated and transferred between containers. The end effector may be a suction device connected to a vacuum source, as per the embodiment shown in FIG. 7B, or another type of end effector such as a jaw gripper or a finger gripper.

In the embodiment shown in FIG. 7B, each robotic manipulator 52 is mounted on a plinth above a single grid cell and is surrounded by eight grid cells. In other embodiments, a given robotic manipulator 52 may be surrounded by fewer grid cells or on fewer sides, depending on the location on the storage system 1. Similarly, FIG. 7B shows the robotic picking stations 50 arranged along both of the orthogonal directions of the grid 15, however, in other embodiments the picking stations 50 may be arranged along only one axis of the grid 15, e.g. in a row or line. In some cases, there may be clusters of robotic picking stations 50 arranged at selected locations on the grid 15 of the storage system 1.

Disposed above the grid 15 is a camera 71 as part of the detection system. In examples, the camera 71 is an ultra wide-angle camera, i.e. comprises an ultra wide-angle lens (also referred to as a “super wide-angle” or “fisheye” lens). The camera 71 includes an image sensor to receive incident light that is focused through a lens, e.g. the fisheye lens. The camera 71 has a field of view 72 including at least a section of the grid 15. Multiple cameras may be used to observe the entire grid 15, e.g. with each camera 71 having a respective field of view 72 covering a section of the grid 15. The ultra wide-angle lens may be selected for its relatively large field of view 72, e.g. up to a 180-degree solid angle, compared to other lens types, meaning fewer cameras are needed to cover the grid 15. Space may also be limited between the top of the grid 15 and a surrounding structure, e.g. a warehouse roof, thus constraining the height of the camera 71 above the grid 15. An ultra wide-angle camera can provide a relatively large field of view at a relatively low height above the grid 15 compared to other camera types.

The one or more cameras 71 can be used to monitor the grid 15 including the robotic picking stations 50. For example, an image feed from the one or more cameras 71 can be displayed on one or more computer monitors remote from the grid 15 to surveil the picking stations 50 (and load handling devices) operating on the grid 15.

The detection system also includes an object detection model trained to detect instances of moving picking stations on the grid. For example, the object detection model is a trained neural network configured to process images to detect a moving picking station in the images. More details on neural networks and non-neural approaches are described below. The detection system is configured to obtain image data representative of a series of images captured by the camera 71 and process the image data with the object detection model. The detection system can then determine, based on the processing, whether the series of images includes a moving picking station of the one or more picking stations. In response to determining that the image includes the moving picking station, the detection system outputs annotation data indicative of the moving picking station in the image. More details on processing the images to detect moving picking stations, and scenarios involving determining locations and even identification (ID) information of the detected picking stations 50 (such as unique ID labels), are described in embodiments below.

### Calibration Process

A monitoring or surveillance system for the grid 15 may incorporate calibration of the one or more cameras 71 positioned above the grid 15, particularly in embodiments comprising wide-angle or ultra wide-angle cameras. Accurate calibration of the (ultra) wide-angle cameras may allow for interaction with the images captured thereby, which are distorted by the (ultra) wide-angle lens, to be mapped correctly to the workspace. Thus, an operator can select areas of pixels in the distorted images which are mapped to corresponding areas of grid spaces, for example. In other scenarios, the (distorted) images from the cameras 71 can be processed to detect picking stations on the grid and output corresponding locations on the grid and even identification information such as unique ID labels.

An example calibration process for an ultra wide-angle camera includes obtaining an image of a section of the grid, i.e. a grid section, captured by the camera. Obtaining the image includes obtaining, e.g. receiving, image data representative of the image, e.g. at a processor. For example, the image data may be received via an interface, e.g. a camera serial interface (CSI). An image signal processor (ISP) may perform initial processing of the image data, e.g. saturation correction, renormalization, white balance adjustment and/or demosaicing, to prepare the image data for display.

Initial values of a plurality of parameters corresponding to the ultra wide-angle camera are also obtained. The parameters include a focal length of the ultra wide-angle camera, a translational vector representative of a position of the ultra wide-angle camera above the grid section, and a rotational vector representative of a tilt and rotation of the ultra wide-angle camera. These parameters are usable in a mapping algorithm for mapping pixels in an image distorted by the ultra wide-angle lens of the camera to a plane oriented with the orthogonal grid 15 of the storage system. The mapping algorithm is described in more detail below.

The calibration process includes processing the image using a neural network trained to detect/predict the tracks in images of grid sections captured by ultra wide-angle cameras.

### Neural Network

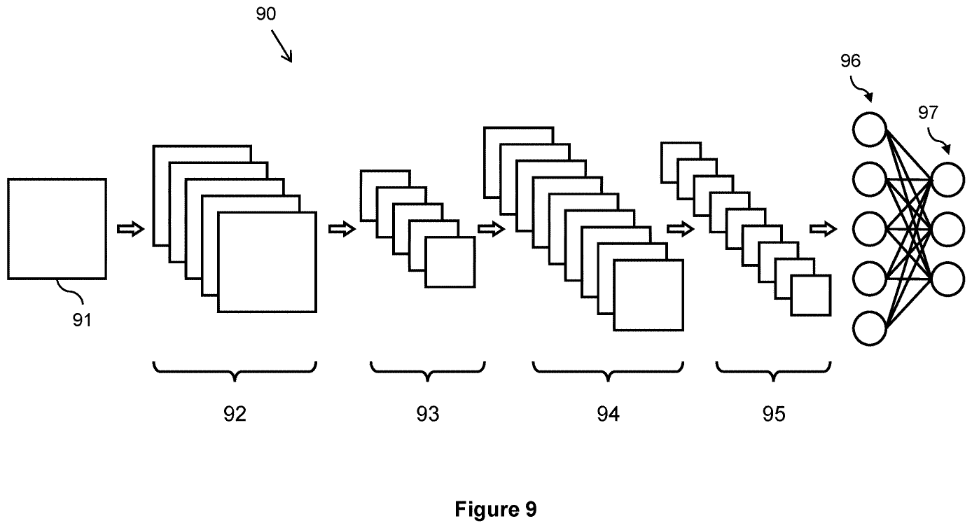

FIG. 9 shows an example of a neural network architecture. The example neural network 90 is a convolutional neural network (CNN). An example of a CNN is the U-Net architecture developed by the Computer Science Department of the University of Freiburg, although other CNNs are usable e.g. the VGG-16 CNN. An input 91 to the CNN 90 comprises image data in this example. The input image data 91 is a given number of pixels wide and a given number of pixels high and includes one or more colour channels (e.g. red, green and blue colour channels).

Convolutional layers 92, 94 of the CNN 90 typically extract particular features from the input data 91, to create feature maps, and may operate on small portions of an image. Fully connected layers 96 use the feature maps to determine an output 97, e.g. classification data specifying a class of objects predicted to be present in the input image 91.

In the example of FIG. 9, the output of the first convolutional layer 92 undergoes pooling at a pooling layer 93 before being input to the second convolutional layer 94. Pooling, for example, allows values for a region of an image or a feature map to be aggregated or combined, e.g. by taking the highest value within a region. For example, with 2×2 max pooling, the highest value of the output of the first convolutional layer 92 within a 2×2 pixel patch of the feature map output from the first convolutional layer 92 is used as the input to the second convolutional layer 94, rather than transferring the entire output. Thus, pooling can reduce the amount of computation for subsequent layers of the neural network 90. The effect of pooling is shown schematically in FIG. 9 as a reduction in size of the frames in the relevant layers. Further pooling is performed between the second convolutional layer 94 and the fully connected layer 96 at a second pooling layer 95. It is to be appreciated that the schematic representation of the neural network 90 in FIG. 9 has been greatly simplified for ease of illustration; typical neural networks may be significantly more complex.

In general, neural networks such as the neural network 90 of FIG. 9 may undergo what is referred to as a “training phase”, in which the neural network is trained for a particular purpose. A neural network typically includes layers of interconnected artificial neurons forming a directed, weighted graph in which vertices (corresponding to neurons) or edges (corresponding to connections) of the graph are associated with weights, respectively. The weights may be adjusted throughout training, altering the output of individual neurons and hence of the neural network as a whole. In a CNN, a fully connected layer 96 typically connects every neuron in one layer to every neuron in another layer, and may therefore be used to identify overall characteristics of an image, such as whether the image includes an object of a particular class, or a particular instance belonging to the particular class.

In the present context, the neural network 90 is trained to perform object identification by processing image data, e.g. to determine whether an object of a predetermined class of objects is present in the image (although in other examples the neural network 90 may have been trained to identify other image characteristics of the image instead). Training the neural network 90 in this way for example generates weight data representative of weights to be applied to image data (for example with different weights being associated with different respective layers of a multi-layer neural network architecture). Each of these weights is multiplied by a corresponding pixel value of an image patch, for example, to convolve a kernel of weights with the image patch.

Specific to the context of ultra wide-angle camera calibration, the neural network 90 is trained with a training set of input images of grid sections captured by ultra wide-angle cameras to detect the tracks 22 of the grid 15 in a given image of a grid section. In examples, the training set includes mask images, showing the extracted track features only, corresponding to the input images. For example, the mask images are manually produced. The mask images can thus act as a desired result for the neural network 90 to train with using the training set of images. Once trained, the neural network 90 can be used to detect the tracks 22 in images of at least part of the grid structure 15 captured by an ultra wide-angle camera.

The calibration process includes processing the image of the grid section captured by the ultra wide-angle camera 71 with the trained neural network to detect the tracks 22 in the image. At least one processor (e.g. a neural network accelerator) may be used to do the processing. The image processing generates a model of the tracks, specifically the first and second sets of parallel tracks, as captured in the image of the grid section. For example, the model comprises a representation of a prediction of the tracks in the distorted image of the grid section as determined by the neural network. The model of the tracks corresponds to a mask or probability map in examples.

Selected pixels in the determined track model are then mapped to corresponding points on the grid 15 using a mapping, e.g. a mapping algorithm, which incorporates the plurality of parameters corresponding to the ultra wide-angle camera. The obtained initial values are used as inputs to the mapping algorithm.

An error function (or “loss function”) is determined based on a discrepancy between the mapped grid coordinates and true, e.g. known, grid coordinates of the points corresponding to the selected pixels. For example, a selected pixel located at the centre of an X-direction track 22a should correspond to a grid coordinate with a half-integer value in the Y-direction, e.g. (x, y.5) where the x is an unknown number and y is an unknown integer. Similarly, a selected pixel located at the centre of an Y-direction track 22b should correspond to a grid coordinate with a half-integer value in the X-direction, e.g. (x′.5, y′) where x′ is an unknown integer and y′ is an unknown number. In examples, the width and length of the grid cells (or a ratio thereof) is used in the loss function, e.g. to calculate the cell x, y coordinate for key points and check whether they are on a track (e.g. a coordinate value of n.5 where n is an integer).

The initial values of the plurality of parameters corresponding to the ultra wide-angle camera are then updated to updated values based on the determined error function. For example, a Broyden-Fletcher-Goldfarb-Shanno (BFGS) algorithm is applied using the error function and initial parameter values as inputs. In examples, the updated values of the plurality of parameters are iteratively determined, with the error function being recalculated with each update. The iterations may continue until the error function is reduced by less than a predetermined threshold, e.g. between successive iterations or compared to the initial error function, or until an absolute value of the error function falls below a predetermined threshold. Other iterative algorithms, e.g. sequential quadratic programming (SQP) or sequential least-squares quadratic programming (SLSQP), can be used with the initial values to generate a sequence of improving approximate solutions for the plurality of parameters, in which a given approximation in the sequence is derived from the previous ones. In certain cases, the iterative algorithm is used to optimise the values of the plurality of parameters. For example, the updated values are optimised values of the plurality of parameters.

The updating of the initial values of the plurality of parameters corresponding to the ultra wide-angle camera involves applying one or more respective boundary values for the plurality of parameters. For example, the boundary values for a rotation angle associated with the rotation vector are substantially 0 degrees and substantially +5 degrees. Additionally or alternatively, the boundary values for a planar component of the translational vector are ±0.6 of a length of a grid cell. Additionally or alternatively, the boundary values for a height component of the translational vector are 1800 mm and 2100 mm, or 1950 mm and 2550 mm, or 2000 mm and 2550 mm above the grid. For example, a lower bound for the camera height is in the range 1800 to 2000 mm. For example, an upper bound for the camera height is in the range 2100 to 2600 mm. Additionally or alternatively, the boundary values for the focal length of the camera are 0.23 and 0.26 cm. Applying the one or more respective boundary values for the plurality of parameters can mean that the updating, e.g. optimisation, process is performed in a feasible region or solution space, i.e. a set of all possible values which satisfy the one or more boundary conditions.

The updated values of the plurality of parameters are electronically stored for future mapping of pixels in grid section images captured by the ultra wide-angle camera 71 to corresponding points on the grid 15 via the mapping algorithm. For example, the stored values of the plurality of parameters are retrieved from data storage and used in the mapping algorithm to compute the grid coordinates corresponding to a given pixel in a given image of the grid section captured by the ultra wide-angle camera 71. In examples, the updated values are stored at a storage location, e.g. in a database, associated with the ultra wide-angle camera 71. For example, a lookup function or table may be used with the database to find the stored parameter values associated with any given ultra wide-angle camera employed in the storage system 1 above the grid 15.

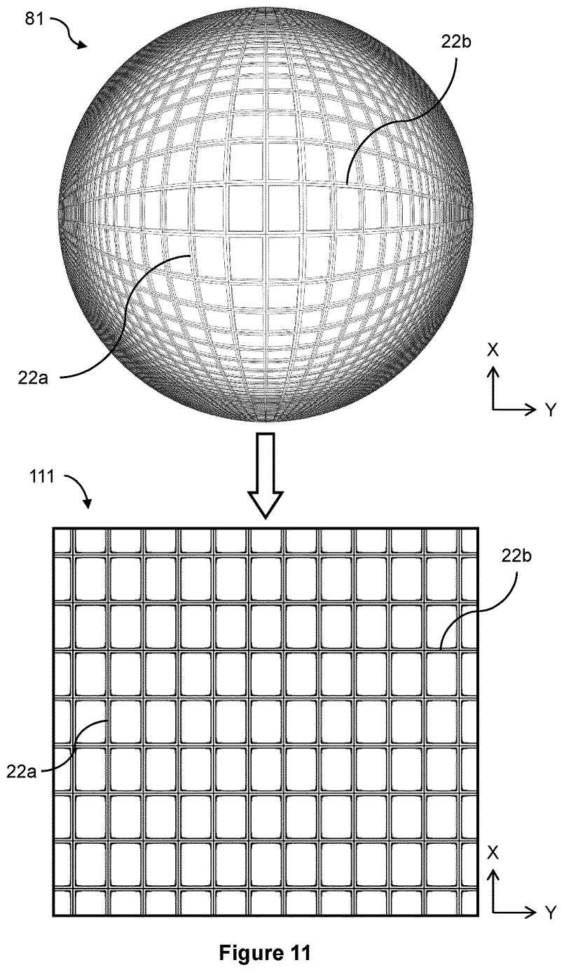

Following calibration of a given camera 71 disposed above the grid 15, an image (e.g. “snapshot”) of a grid section captured by the camera 71 can be flattened, i.e. undistorted, for interaction by an operator. For example, using the image-to-grid mapping function as described, the distorted image 81 of the grid section can be converted into a flattened image 111 of the grid section, as shown in the example of FIG. 11. The flattening involves selecting an area of grid cells to flatten in the distorted image 81, and inputting grid coordinates corresponding to those cells into the mapping function which determines which respective pixel values from the distorted image 81 should be copied into the flattened image 111 for the respective grid coordinates. A target resolution, e.g. in pixels per grid cell, can be set for the flattened image 111, which may have a ratio corresponding to the ratio of the grid cell dimensions. Once all the pixel values needed in the flattened image (per the target resolution and selected number of grid cells) are determined, the flattened image 111 can be generated.

The snapshots may be captured by the camera 71 at predetermined intervals, e.g. every ten seconds, and converted into corresponding flattened images 111. The most recent flattened image 111 is stored in storage for viewing on a display, for example, by an operator wishing to view the grid section covered by the camera 71. The operator may instead choose to retake a snapshot of the grid shot and have it flattened. The operator can thus select regions, e.g. pixels, in the flattened image 111 and have those selected regions converted to grid coordinates based on the image-to-grid mapping function as described herein. In some cases, the flattened image 111 includes annotations of the grid coordinates for the grid spaces viewable in the flattened image 111. The flattened images 111 corresponding to each camera 71 may be more user-friendly for monitoring the grid 15 compared to the distorted images 81.

### Grid to Image Mapping

Mapping real-world points on the grid 15 to pixels in an image captured by a camera is done by a computational algorithm. The grid point is first projected onto a plane corresponding to the ultra wide-angle camera 71. For example, at least one of a rotation using the rotation matrix and a planar translation in the X- and Y-directions is applied to the point having x, y, and z coordinates in the grid framework structure 14. The focal length f of the ultra wide-angle camera may be used to project the point with three-dimensional coordinates relative to the grid 15 onto a two-dimensional plane relative to the ultra wide-angle camera 71. For example, the coordinates of the mapped point q in the plane of the ultra wide-angle camera 71 are calculated as q=f·p_{[x,y]}÷p_{z}, where p_{[x,y]} and p_{z} are the planar x-y coordinates and third z coordinate of the point p relative to the grid 15, respectively.

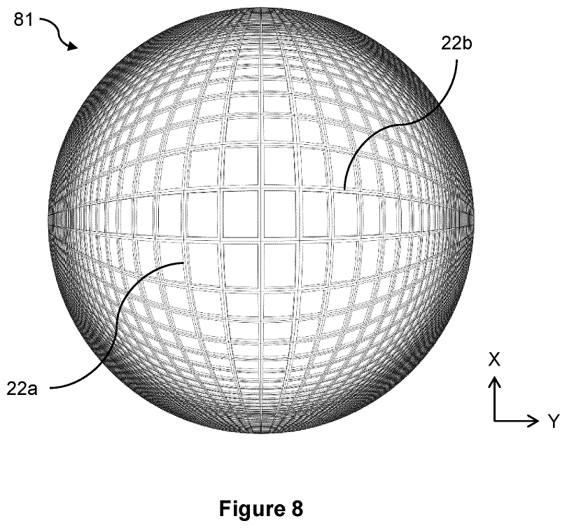

The point q projected onto the ultra wide-angle camera plane may be aligned with a cartesian coordinate system in the plane to determine first cartesian coordinates of the point. For example, aligning the point with the cartesian coordinate system involves rotating the point, or a position vector of the point in the plane (e.g. a vector from the origin to the point). The rotation is thus to align with the typical grid orientation in the images captured by the camera, for example, but may not be necessary if the X- and Y-directions of the grid are already aligned with the captured images. The rotation is substantially 90 degrees in examples. As shown in FIGS. 8A and 8B, the X- and Y-directions of the grid are offset by 90 degrees with respect to the horizontal and vertical axes of the image; thus the rotation “corrects” this offset such that the X- and Y-directions of the grid align with the horizontal and vertical axes of the captured images.

The grid-to-image mapping algorithm continues with converting the first cartesian coordinates into first polar coordinates using standard trigonometric methods. A distortion model is then applied to the first polar coordinates of the point to generate second, e.g. “distorted”, polar coordinates. In examples, the distortion model comprises a tangent model of distortion given by r′=f·arctan (r/f), where r and r′ are the undistorted and distorted radial coordinates of the point, respectively, and f is the focal length of the ultra wide-angle camera.

The second polar coordinates are then converted back into (second) cartesian coordinates using the same standard trigonometric methods in reverse. The image coordinates of the pixel in the image are then determined based on the second cartesian coordinates. In examples, this determination includes at least one of de-centering or re-scaling the second cartesian coordinates. Additionally or alternatively, the ordinate (y-coordinate) of the second cartesian coordinates is inverted, e.g. mirrored in the x-axis.

### Image to Grid Mapping

Mapping pixels in an image captured by the camera 71 to real-world points on the grid 15 is done by a different computational algorithm. For example, the image-to-grid mapping algorithm is an inverse of the grid-to-image mapping algorithm described above, with each mathematical operation being inverted.

For a given pixel in the image, (second) cartesian coordinates of the mapped point are determined based on image coordinates of the pixel in the image. For example, this determination involves initialising the pixel in the image, e.g. including at least one of centering or normalising the image coordinates. As before, the ordinate is inverted in some examples.

The second cartesian coordinates are converted into second polar coordinates using the mentioned standard trigonometric methods. The use of the label “second” is used for consistency with the conversions done in the described grid-to-image algorithm, but is arbitrary.

An inverse distortion model is applied to the second polar coordinates to generate first, e.g. “undistorted”, polar coordinates. In examples, the inverse distortion model is based on a tangent model of distortion given by r=f·tan (r′/f), where again r′ is the distorted radial coordinate of the point, r is the undistorted radial coordinate of the point, and f is the focal length of the ultra wide-angle camera. Thus, in examples, the inverse distortion model used in the image-to-grid mapping is an inverse function, or “anti-function”, of the distortion model used in the grid-to-image mapping.

The image-to-grid mapping algorithm continues with converting the first polar coordinates into first cartesian coordinates. The first cartesian coordinates may be de-aligned, or unaligned, with a cartesian coordinate system in the plane corresponding to the ultra wide-angle camera. For example, de-aligning the point with the cartesian coordinate system involves applying a rotational transformation to the point, or a position vector of the point in the plane (e.g. a vector from the origin to the point). The rotation is substantially 90 degrees in examples. This rotation may thus “undo” any “correction” to an offset between the X- and Y-directions of the grid and the horizontal and vertical axes of the captured images previously described in the grid-to-image mapping.

Finally, the point is projected from the (second) plane corresponding to the camera 71 onto the (first) plane corresponding to the grid 15 to determine grid coordinates of the point relative to the grid.

In examples, projecting the point onto the plane corresponding to the grid 15 involves computing p=B⁻¹·(f·t−q·z), where B=q·R_{3,[1,2]}−f·R_{[1,2],[1,2]}. In these equations, p comprises point coordinates in the grid plane, q comprises cartesian coordinates in the camera plane, and f is the focal length of the ultra wide-angle camera as before. Furthermore, t is a planar translation vector, z is a distance (e.g. height) between the ultra wide-angle camera and the grid, and R is a three-dimensional rotation matrix related to a rotation vector. The rotation vector comprises a direction representing the rotation axis of the rotation and a magnitude representing the angle of rotation. The rotation matrix R corresponding to the angle-axis rotation vector can be determined from the vector, e.g. using Rodrigues' rotation formula.

A mathematical derivation of the function for projecting the undistorted 2D point q from the camera plane is now provided for completeness. Beginning with the grid to image projection from above: q=f·p′_{[x,y]}÷p′_{z}, where p′ is the rotated and translated grid point p: p′=R·p+(tₓ, t_{y}, z)^{T}, we are aiming to derive p from q. Rearranging and substituting for p′ gives:

$${p}_{z}^{′} \cdot q = f \cdot {p}_{[ x , y ]}^{′} ⇔ {( R \cdot p + {( {t}_{x} , {t}_{y} , z )}^{T} )}_{z} \cdot q = f \cdot {( R \cdot p + {( {t}_{x} , {t}_{y} , z )}^{T} )}_{[ x , y ]} ⇔ ( {( R \cdot p )}_{z} + z ) \cdot q = f \cdot ( {( R \cdot p )}_{[ x , y ]} + t ) ⇔ {( R \cdot p )}_{z} \cdot q + z \cdot q = f \cdot {( R \cdot p )}_{[ x , y ]} + f \cdot t ⇔ {( R \cdot p )}_{z} \cdot q - f \cdot {( R \cdot p )}_{[ x , y ]} = f \cdot t - z \cdot q$$

Since the desired distance of the point p on the grid from the camera is given by the height parameter z, it can be assumed in the translation of the point that p_{z}=0. Thus, all p_{z} terms can be removed to leave:

$$( {R}_{3 , [ 1 , 2 ]} \cdot {p}_{[ x , y ]} ) \cdot q - f \cdot {R}_{[ 1 , 2 ] , [ 1 , 2 ]} \cdot {p}_{[ x , y ]} = f \cdot t - z \cdot q ⇔ ( q \cdot {R}_{3 , [ 1 , 2 ]} - f \cdot R ) \cdot {p}_{[ x , y ]} = f \cdot t - z \cdot q$$

By defining a matrix B=(q·R_{3,[1,2]}−f·R), the expression can be further simplified to B·p_{[x,y]}=f·t−z·q, which resolves as the equation above for computing the point p by using the inverse matrix B⁻¹.

Returning to the calibration process, in some cases grid cell coordinate data encoded in grid cell markers positioned about the grid 15 can be used to calibrate the computed grid coordinates corresponding to a pixel in a captured image. For example, the grid cell markers are signboards, e.g. placed in predetermined grid cells 17, with corresponding cell coordinate data marked on each signboard. The process includes, for example, processing the captured image to detect a grid cell marker in the image and then extracting the grid cell coordinate data encoded in the grid cell marker to use in calibrating the mapped grid coordinates. Each grid cell marker is located in a respective grid cell, for example located below a respective camera 71 in the field of view 72 thereof.

The image processing may involve using an object detection model, e.g. a neural network, trained to detect instances of grid cell markers in images of grid sections. A computer vision platform, e.g. the Cloud Vision API (Application Programming Interface) by Google®, may be used to implement the object detection model. The object detection model may be trained with images of grid sections including grid cell markers. In examples where the object detection model includes a neural network, e.g. a CNN, the description with reference to FIG. 9 applies accordingly.

The grid coordinates—generated by the mapping of pixels in the captured image to points on the grid section represented in the image—can be calibrated to the entire grid based on the extracted cell coordinate data. For example, the mapped grid point corresponding to a given pixel comprises coordinates in units of grid cells, e.g. (x, y) with a number x of grid cells in the X-direction and a number y of grid cells in the Y-direction. However, the grid cells captured by the camera 71 are of a grid section, i.e. a section of the grid 15, and thus not necessarily the entire grid 15. Thus the mapped grid coordinates (x, y) relative to the grid section captured in the image may be calibrated to grid coordinates (x′, y′) relative to the entire grid based on the relative location of the grid section with respect to the entire grid. The location of the grid section relative to the entire grid can be determined by extracting the grid cell coordinate data encoded in a grid cell marker captured in the image, as described.

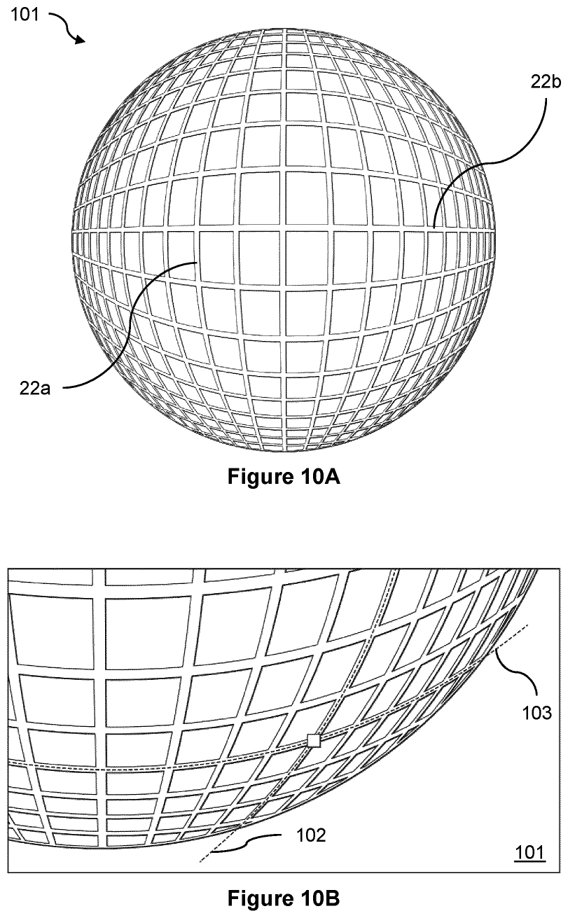

FIG. 10A shows an example model 101 of the tracks generated by processing an image 81 of a grid section, as captured by the ultra wide-angle camera 71, with the trained neural network 90 to detect the tracks 22 in the image. The model 101 comprises a representation of a prediction of the tracks 22a, 22b in the distorted image of the grid section as determined by the neural network 90. Mapping pixels from the track model 101 to corresponding points on the grid 15 can be done to calibrate the camera 71 as described. For example, the calibration involves updating, e.g. optimising, the plurality of parameters associated with the camera 71 that are used for mapping between pixels in the captured images 81 and points on the grid 15.

In examples, the model 101 of the grid section can be refined to represent only centrelines of the first 22a and second 22b sets of parallel tracks. Thus, the pixels to be mapped from the track model 101 to corresponding points on the grid 15 are, for example, pixels lying on a centreline of the first 22a or second 22b sets of parallel tracks in the generated model 101. The refining involves, for example, filtering the model with horizontal and vertical line detection kernels. The kernels allow the centrelines of the tracks to be identified in the model 101, e.g. in the same way other kernels can be used to identify other features of an image such as edges in edge detection. Each kernel is a given size, e.g. a 3×3 matrix, which can be convolved with the image data in the model 101 with a given stride. For example, the horizontal line detection kernel is representable as the matrix:

$$[ \begin{matrix}0 & 0 & 0 \\ 1 & 1 & 1 \\ 0 & 0 & 0\end{matrix} ] .$$

Similarly, the vertical line detection kernel is representable, for example, as the matrix:

$$[ \begin{matrix}0 & 1 & 0 \\ 0 & 1 & 0 \\ 0 & 1 & 0\end{matrix} ] .$$

In examples, the filtering involves at least one of eroding and dilating pixel values of the model 101 using the horizontal and vertical line detection kernels. For example, at least one of an erosion function and a dilation function is applied to the model 101 using the kernels. The erosion function effectively “erodes” away the boundaries of a foreground object, in this case the tracks 22a, 22b in the generated model 101, by convolving the kernel with the model. During erosion, pixel values in the original model (either ‘1’ or ‘0’) are updated to a value of ‘1’ only if all the pixels convolved under the kernel are equal to ‘1’, otherwise it is eroded (updated to a value of ‘0’). Effectively all the pixels near the boundary of the tracks 22a, 22b in the model 101 will be discarded, depending upon the size of kernel used in the erosion, such that the thickness of each of the tracks 22a, 22b decreases to substantially the centreline thereof. The dilation function is the opposite of the erosion function and can be applied after erosion to effectively “dilate” or widen the centreline remaining after the erosion. This dilation can stabilise the centrelines of the tracks 22a, 22b in the refined model 101. During dilation, pixel values are updated to a value of ‘1’ if at least one pixel convolved under the kernel is equal to ‘1’. The erosion and dilation functions are applied respectively to the original generated model 101, for example, with the resulting horizontal centreline and vertical centreline “skeletons” being combined to produce the refined model.

In some cases, the generated model 101 may have missing sections of the tracks 22a, 22b, for example where one or more regions of the grid section viewable by the camera 71 are obscured. Objects on the grid 15 such as transport devices 30, pillars or other structures may obscure parts of the track in the captured image. Thus, the generated model 101 can have the same missing regions of track. Similarly, false positive predictions of the tracks may be present in the generated model 101.

To help with these problems, the tracks 22a, 22b present in the generated model (e.g. the centrelines thereof) can be fitted to respective quadratic equations, e.g. to produce quadratic trajectories for the tracks 22a, 22b. FIG. 10B shows an example of a track of the first set of tracks 22a in the model 101 being fitted to a first quadratic trajectory 102 and a track of the second set of tracks 22b in the model 101 being fitted to a second quadratic trajectory 103. Quadratic track centrelines can then be produced based on the quadratic trajectories, e.g. by extrapolating pixel values along the quadratic trajectories to fill in any gaps or remove any false positives in the model 101. For example, if a sub-line generated from a predicted grid model 101 cannot be fitted to a given quadratic curve together with at least one other line, then it is very unlikely to be part of the grid and should be excluded.

The quadratic equations, y=ax²+bx+c, used for fitting the tracks in the model 101 may also have specified boundary conditions, for example:

$$500 < \frac{- b}{2 a} < 2500 ;$$

−9.9×10⁻⁴<a<9.9×10⁻⁴; −5<b<5; and 0<<<3200.

In examples, a predetermined number of pixels are extracted from the refined model 101 of the tracks, e.g. to reduce the storage requirements to store the model. For example, a random subset of pixels are extracted to give the final refined model 101 of the tracks.

Calibrating the ultra wide-angle cameras 71 using the systems and methods described herein allows for images captured by the cameras 71 with a wide field of view of the grid 15 to be used to detect and localise transport devices thereon, for example. This is despite the relatively high distortion present in the images compared to those of other camera types.

The automatic calibration process outlined above can also reduce the time taken to calibrate each camera 71 installed above the grid 15 of the storage system compared to manual methods of tuning the parameters associated with the respective cameras 71. For example, combining the neural network model, e.g. U-Net, with the customised optimisation function to implement the calibration pipeline as described can remove more than 80% of errors compared to standard calibration methods. Furthermore, the calibration systems and methods described herein have proved to be versatile and consistent enough to calibrate the cameras in multiple warehouse storage systems, e.g. with differing dimensions, scale, and layout.

Furthermore, the output flattened calibrated image 111 of the grid allows for easier interaction with the image 111, by both humans and machines, for monitoring the grid 15 and the picking stations 50 and transport devices 30 moving thereon.

### Detecting a Moving Picking Station

Provided herein are methods and systems for processing images, e.g. distorted images 81, captured by the one or more cameras 71 to detect moving picking stations 50 on the grid 15 of a grid-based storage system 1. For example, locations of the detected picking stations 50 relative to the grid 15 can be outputted. In some examples, identification (ID) information of the detected picking stations 50, e.g. unique ID labels, can be outputted. Such examples will now be described in more detail.

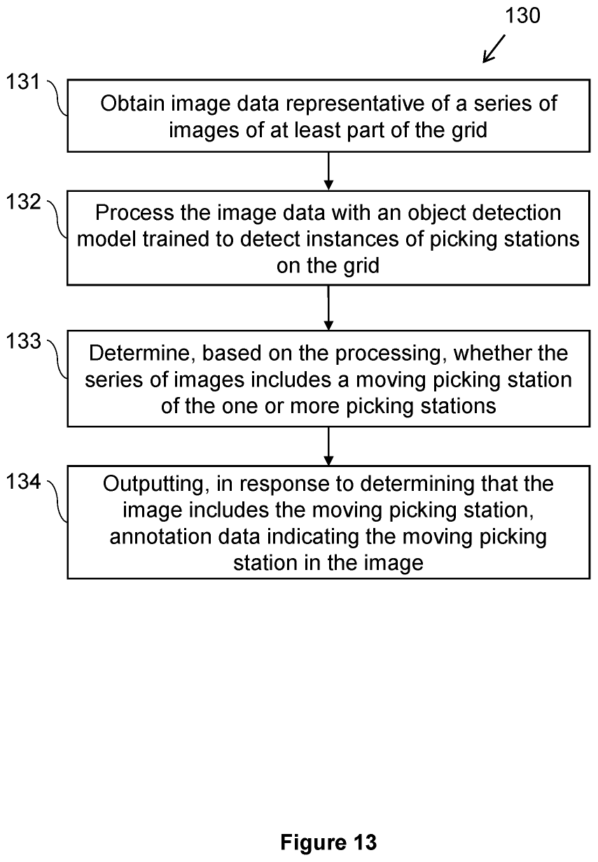

FIG. 13 shows a computer-implemented method 130 of detecting a moving picking station 50 on the grid 15. The method 130 involves obtaining 131 and processing 132 image data, representative of a series of images of at least part of the grid 15, with an object detection model trained to detect instances of picking stations on the grid. For example, the images are captured by a camera 71 with a field of view 72 covering at least part of the grid 15 and the image data is transferred to the computer for implementing the detection method 130. The image data is received at an interface, e.g. a CSI, of the computer, for example.

The object detection model may be a neural network, e.g. a convolutional neural network, trained to perform object detection of picking stations 50 on the grid 15 of the workspace. The description of neural networks with respect to FIG. 9 therefore applies in these specific examples. In the present context, the object detection model, e.g. CNN 90, is trained to perform object identification by processing the obtained image data to determine whether an object of a predetermined class of objects (i.e. a picking station) is present in the image. Training the neural network 90, for example, involves providing training images of workspace sections with picking stations present to the neural network 90. Weight data is generated for the respective (convolutional) layers 92, 94 of a multi-layer neural network architecture and stored for use in implementing the trained neural network. In examples, the object detection model comprises a “You Only Look Once” (YOLO) object detection model, e.g. YOLOv4 or Scaled-YOLOv4, which has a CNN-based architecture. Other example object detection models include neural-based approaches such as RetinatNet or R-CNN (Regions with CNN features) and non-neural approaches such as a support vector machine (SVM) to do the object classification based on determined features, e.g. Haar-like features or histogram of oriented gradients (HOG) features.

The method 130 involves determining 133, based on the processing 132, whether the image includes a moving picking station 50. For example, the object detection model is configured, e.g. trained or learnt, to detect whether a moving picking station 50 is present in a captured series of images of the grid 15. In examples, the object detection model makes the determination 133 with a level of confidence, e.g. a probability score, corresponding to a likelihood that the image includes a moving picking station 50. A positive determination may thus correspond to a confidence level above a predetermined threshold, e.g. 90% or 95%. In response to determining 133 that the image includes the moving picking station, annotation data (e.g. prediction data or inference data) indicative of the predicted picking station in the image is output 134. An updated version of one or more images in the series of images, including the annotation data, may be output as part of the method 130, for example.

In examples, the object detection model is trained with an additional temporal dimension, e.g. to receive a series of grid images as input and detect moving picking stations in the series of images. For example, the object detection model (such as a CNN) is trained based on a dataset of multiple image series comprising moving and non-moving picking stations on the grid.

In other examples, the object detection model is configured, e.g. trained, to detect instances of picking stations 50 in each image of a series of images. A trajectory model may be employed to determine the changing object detection model parameters. Alternatively, the object detection model is configured to detect the picking station and its motion in a single object-trajectory parameterized model, e.g. from a series of sets of detected edges indicating edge movement in the series of image frames.

In general, moving object detection involves segmenting non-stationary objects of interest with respect to a surrounding area or region from a given series of images (e.g. video frames). Thus, as described, moving object detection, and any further object tracking, involves detecting foreground moving object(s): either in every frame or at the first instance of the moving object in the image sequence (e.g. video).

Detecting foreground objects, i.e. the moving picking stations 50 on the grid 15, may involve a background subtraction method, e.g. in which a background model is initialised before a difference between a given frame and the background model is obtained by a pixelwise comparison of the given frame with the background model colour map. For example, if a difference between respective pixels in the colour maps is more than a predetermined threshold, the corresponding pixel in the given frame is considered to belong to the foreground. Example background subtraction techniques include: concurrence of image variations, eigen backgrounds, mixture of gaussians, Kernel Density Estimation (KDE), Running Gaussian average, Sequential Kernel Density approximation, and a temporal median filter.

In examples, the object detection model is configured to identify the presence of a moving picking station by frame differencing. Frame differencing involves computing a difference between at least two image frames, e.g. consecutive frames, in the series of images. For example, an image subtraction operator may be used to obtain an output image by subtracting a second image frame from a first image frame in corresponding frames of the series of images.

In certain cases, the frame differences are determined pixelwise, e.g. the differences are computed in a per-pixel way. For example, temporal differencing involves detecting the moving object by employing a pixel-wise differencing method between at least two successive frames.

An alternative “optical flow” approach to moving object detection involves calculating an optical flow field of an image (or video frame). Clustering may be performed on the basis of the optical flow distribution information obtained from the image.

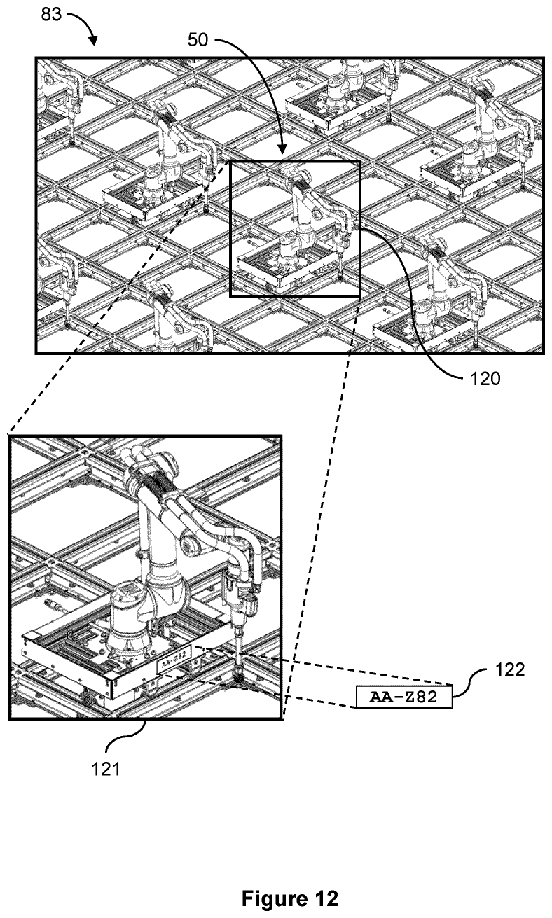

In examples, the annotation data outputted as part of the detection method comprises bounding box data. FIG. 12 shows an example of an updated version 83 of an image, captured in a series of images by the camera 71, annotated with a bounding box 120 based on bounding box data. The bounding box 120 corresponds to a picking station 50 detected by the object detection model. A given bounding box comprises a rectangle that surrounds the detected object, for example, and may specify one or more of an image position, identified class (e.g. picking station) and a confidence score (e.g. how likely the object is to be present within the box). Bounding box data defining the given bounding box may include coordinates of two corners of the box or a centre coordinate with width and height parameters for the box in the image 83. In examples, the detection method 130 involves generating the annotation data, e.g. representable as a bounding box 120, for outputting.

In some cases, the object detection model is further trained to detect instances of faulty picking stations in the workspace, e.g. picking stations unresponsive to communications from the master controller and/or with a warning signal engaged.

For example, the method 130 may involve processing the image data with the object detection model to determine, based on the processing, whether the image includes a picking station with a warning signal engaged. The warning signal of the picking station comprises a predetermined light, or colour of light, emitted by a light source on the picking station-such as a light emitting diode (LED). For example, the picking stations include an LED which is configured to emit a first wavelength (colour) of light when responsive to communications from the master controller and emit a second, different, colour wavelength (colour) of light when unresponsive to communications from the master controller. The picking station may be in an unresponsive state when communication with the master controller is lost, for example, causing the warning signal to be engaged. Other types of warning signal from the light source are possible, for example a predetermined pattern of emission such as flashing. In response to determining that the image includes the unresponsive picking station, the method 130 may include outputting at least one of annotation data or an alert. The annotation data indicates the predicted picking station with the warning signal engaged in the image. For example, the annotation data comprises a bounding box surrounding the predicted picking station with the warning signal engaged in the image. Similarly, the outputted alert signals that the image includes the picking station with the warning signal engaged. Examples of an outputted alert include a text or other visual message to be displayed, e.g. on a screen for viewing by an operator.

### Localisation of Picking Stations

The detection method in some examples involves localising the detected picking station(s) on the grid. For example, the method involves obtaining a target image portion which includes at least part of the moving picking station, and mapping the target image portion to a target location on the grid. A location of the moving picking station on the grid can then be determined based on the mapped target location. In some cases, the target image portion (of a given image in the series of images) is determined based on the annotation data obtained as part of the detection method.

In examples, mapping the target image portion (e.g. one or more pixels in the image) to the target location (e.g. a point on the grid structure) involves inversing a distortion of the image of the workspace. For example, where the image sensors are used in combination with an ultra wide-angle lens, the lens distorts the view of the workspace. Thus, the distortion is inversed, for example, as part of the mapping between the image pixels and grid points. An inverse distortion model may be applied to the target image portion for this purpose. The discussion of an image-to-grid mapping algorithm in earlier examples applies here accordingly. For example, mapping the target image portion to the target grid location involves applying the image-to-grid mapping algorithm described herein.

The target image portion may be obtained via the object detection system configured to detect moving picking stations in a series of images of the grid. For example, the process involves the object detection system obtaining the images of the grid captured by the one or more image sensors and determining, using an motion detection algorithm, that a moving picking station is present in the image data.

In other examples, a user viewing the image representation of the grid 15 selects the target image portion via an interface configured to obtain the target image portion. The interface may be a user interface for the user to interact with, for example. The user interface may include a display screen to display the image representation of the workspace captured by the image sensors. The user interface may also include input means, e.g. a touch screen display, keyboard, mouse, or other suitable means, with which the user can select the target image portion.

In examples, the target image portion includes at least part of a picking station 50 located on the grid 15. For example, the target image portion is a subset of one or more pixels selected from the image of the grid 15 captured by the image sensors. The one or more pixels correspond to at least part of a picking station, detected to be in motion, shown in the images of the grid 15. For example, the target image portion includes the whole picking station 50 shown in the images. In other examples, the target image portion is only a single pixel corresponding to a part of the picking station shown in the images.

In some examples, the target image portion corresponds to a given grid cell in the grid 15 on which the picking station is mounted, e.g. on a plinth. For instance, the target image portion is a subset of one or more pixels corresponding to at least part of the given cell. In some cases, the target image portion includes the whole cell while in other cases the target image portion is only a single pixel corresponding to a part of the cell.

In examples, localising a detected moving picking station 50 on the grid as part of the detection method 130 includes generating further annotation data corresponding to a plurality of virtual picking stations located at respective grid spaces in a captured image of the grid. The location of the detected picking station 50 on the grid 15 can be determined by comparing the annotation data indicative of the detected picking station in the image with the further annotation data corresponding to the plurality of virtual picking stations. For example, the comparison includes calculating intersection over union (IoU) values based on the annotation data. The grid space corresponding to the further annotation data that is associated with the highest IoU value may then be selected as the grid location of the detected picking station.

In examples, the further annotation data comprises bounding box data corresponding to a plurality of bounding boxes associated with the plurality of virtual picking stations. Calculating the IoU values may thus involve dividing an area of overlap, or “intersection”, between two bounding boxes by an area of union of the two bounding boxes (e.g. a total area covered by the two boxes). For example, the area overlap between the bounding box of the detected picking station and a given bounding box corresponding to a given virtual picking station is computed and divided by the area of union for the same two bounding boxes. This calculation is repeated for the bounding box of the detected picking station and each bounding box corresponding to a respective virtual transporting device to give a set of IoU values. The highest IoU value in the set of IoU values may then be selected and the grid location of the corresponding bounding box is inferred as the grid location of the detected picking station.

The previously described detection system may be configured to perform any of the detection methods described herein. For example, the detection system includes an image sensor to capture the images of at least part of the grid and an interface to obtain the image data. The detection system includes the trained object detection model, e.g. implemented on a graphics processing unit (GPU) or a specialised neural processing unit (NPU), to carry out the processing and determining steps of the computer-implemented method 130 of detecting a moving picking station 50.

The described systems and methods for detecting moving picking stations 50 on the grid 15 of a grid-based ASRS allow for a moving picking station to be distinguished from the other, e.g. non-moving, picking stations on the grid 15. For example, a given camera 71 in an array of cameras with a view of the grid 15 may have multiple picking stations 50 in its view. Thus, detecting which picking station 50 is moving allows for that picking station to be distinguished from the other stations, e.g. to check that it is the correct station being caused to move in accordance with a test or inspection. The motion detection can be correlated with other information, for example an identifier on the picking station (as described in other examples herein), as a further check that the moving picking station is supposed to be moving.

Furthermore, in response to determining that the image feed captured by a camera 71 above the grid 15 includes the moving picking station 50, it may be determined whether one or more persons are in proximity to the moving picking station 50. For example, the image data may be processed with a further object detection model trained to detect instances of humans to determine, based on the processing, whether one or more persons are near the moving picking station 50. The determination of proximity may be based on a distance threshold, for example a positive determination is made if a person is detected on the grid within a predetermined distance of the moving picking station, e.g. the grid cell on which the moving picking station is located. Additionally, or alternatively, the proximity determination may be made based on whether one or more persons are located at any of the designated grid cells adjacent to, e.g. surrounding, the moving picking station. In response to a positive determination that one or more persons are in proximity to the moving picking station, the detection system may cause the moving picking station 50 to be stopped, e.g. switched off.

In further examples, the detection system may cause an exclusion zone to be set in response to detecting a moving picking station. For example, if it is intended to shut down a selected number of picking stations on the grid, e.g. to allow the transport devices to make use of the designated grid cells adjacent to the selected picking stations, the detection method can be used to determine if any of the selected picking stations are still active. In response to a positive determination, an exclusion zone corresponding to the designated grid cells adjacent to the detected picking station is determined, which may be set such that the transport devices are prohibited from entering the exclusion zone. Similarly, the detection method may be used to detect unscheduled movements of picking stations 50 on the grid 15, in response to which exclusion zone data is determined representative of an exclusion zone that may be implemented around the picking station 50.

In other examples, an exclusion zone may be determined in response to detecting a faulty picking station, e.g. one which is unresponsive to communications from the master controller and/or with a warning signal engaged. For example, an exclusion zone corresponding to the designated grid cells adjacent to the detected picking station may be determined and subsequently implemented such that the transport devices are prohibited from entering the exclusion zone while the picking station is faulty, e.g. unresponsive.

In the described examples in which an exclusion zone is determined, the determined exclusion zone may comprise a discrete number of grid spaces. For example, the exclusion zone is determined to extend to each grid space adjacent to the grid space of the detected picking station 50 such that other transport devices are prohibited from entering those grid spaces. Collisions with the picking station, e.g. by transport devices moving on the grid 15, can thus be prevented, for example. In some cases, the exclusion zone may be set as a region of grid cells, e.g. a 5×5 cell area, centred on the grid cell at which the detected picking station 50 is located. Thus, the exclusion zone includes a buffer area around the affected picking station 50. The size of the buffer area may be predetermined, e.g. as a set area of grid cells to be applied around a determined grid cell of the detected picking station 50. Additionally, or alternatively, the size of the buffer area is a selectable parameter when implementing the exclusion zone at the control system.

The control system, e.g. master controller, which remotely controls movement of the transport devices 30 operating on the grid 15 can implement the exclusion zone based on the exclusion zone data output as part of the detection process. For example, each of the one or more transport devices is remotely operable under the control of the control system, e.g. central computer. Instructions can be sent from the control system to the one or more transport devices 30 via a wireless communications network, e.g. implementing one or more base stations, to control movement of the one or more transport devices 30 on the grid 15. A separate controller in each transport device 30 is configured to control various driving mechanisms of the transport device, e.g. vehicle 32, to control its movement. For example, the instruction includes various movements in the X-Y plane of the grid structure 15, which may be encapsulated in a defined trajectory for the given transport device. A given exclusion zone can thus be implemented by the central control system, e.g. master controller, so that the defined trajectories avoid the exclusion zone represented by the exclusion zone data. For example, when the exclusion zone is implemented, one or more respective trajectories corresponding to one or more transport devices 30 on the grid are updated to avoid the exclusion zone.

### Detecting an Identification Marker on a Picking Station

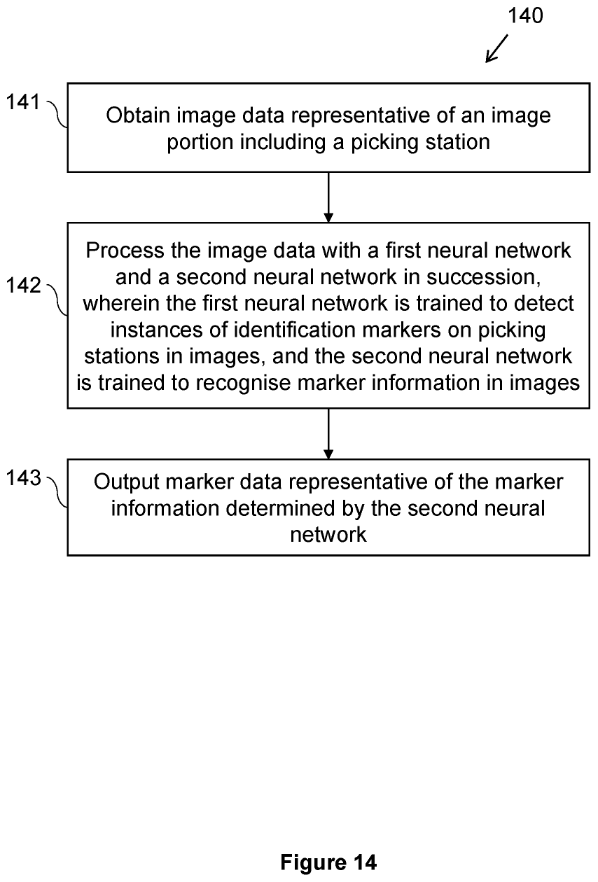

FIG. 14 shows a computer-implemented method 140 of detecting an identification marker on a picking station located on the grid 15. The method involves obtaining 141 image data representative of an image portion including the picking station. The image portion may be a portion, e.g. at least part of, of an image 81, 83 captured by a camera 71 positioned above the grid, e.g. as depicted in FIGS. 7A and 7B.

Returning to FIG. 12, an example image portion 121 including a detected picking station 50 is shown. The image portion 121 may be extracted from the image 83 based on annotation data, e.g. represented as a bounding box 120, corresponding to the detected picking station 50 in the image 83. For example, the output annotation data of the method 130 for detecting moving picking stations on the grid 15 is used to obtain, e.g. extract, the image portion 121 from the image 83. Where the annotation data represents one or more bounding boxes, for example, one or more image portions 121 corresponding to the image data contained in the one or more bounding boxes 120 overlaid on the image 83 are extracted from the image 83. For example, the detection method 140 involves obtaining the annotated image data 83, including the annotation data 120 indicating one or more picking stations in the image, and cropping the annotated image data 83 to produce the one or more image portions 121 including the respective one or more picking stations 50.

In alternative examples, the image portion comprises the entire image 83 including one or more picking stations 50 as captured by the camera 71. In other words, the image portion comprises at least part of the image 83 captured by the camera 71, for example.

The detection method 140 further involves processing 142 the obtained image data with a first neural network and a second neural network in succession. The first neural network is trained to detect instances of identification markers on picking stations in images. The second neural network is trained to recognise marker information, associated with identification markers, in images. The identification (“ID”) marker is a text label, or other code (such as a barcode, QR code or suchlike) on a picking station, for example. The ID marker includes marker information, e.g. the text or QR code, associated with the marker. The marker information corresponds with ID information for the picking station, e.g. a name or other descriptor, of the picking station in the wider system, for example. The marker information is encoded in the ID marker, e.g. as the text or other code, and the corresponding ID information can be used to distinguish a given picking station from the other picking stations operating in the system.

In examples, the first neural network is configured, e.g. trained or learnt, to receive the image portion as first input data and produce feature vectors as intermediate data, e.g. for transferring to the second neural network as an input thereto. For example, the first neural network comprises a CNN 90 which is configured to use convolutions to extract visual features, e.g. of different sizes, and produce the feature vectors. The “Efficient and Accurate Scene Text” (EAST) detector may be used as the first neural network for identifying the instances of identification markers, e.g. text labels, on the picking stations.

In some cases, the first neural network outputs further annotation data, e.g. defining a bounding box, corresponding to the detected identification marker in the image portion. For example, the image processing 142 involves determining, based on the processing with the first neural network, whether the image portion includes an identification marker on the picking station. If the determination is positive, further annotation data corresponding to the location of the identification marker in the image portion is generated and outputted as part of the method 140. The further annotation data may comprise image coordinates relative to the image 83 or image portion 121. For example, the image coordinates correspond to at least two corners of a bounding box for the identification marker in the image portion. The bounding box can be defined by the coordinates of two opposite corners, for example.

In examples, the image processing 142 involves extracting a sub-portion of the image portion, the sub-portion corresponding to the detected identification marker on the picking station 50. For example, the image portion is cropped to generate the sub-portion including the identification marker. FIG. 12 shows an example sub-portion 122 corresponding to the detected identification marker on the picking station 50 as extracted from the image portion 121. The sub-portion 122 may be rotated such that a longitudinal axis of the identification marker lies substantially horizontal relative to the sub-portion 122, as shown in the example of FIG. 12. The method 140 may then include processing the sub-portion 122 with the second neural network configured, e.g. trained or learnt, to recognise marker information in images.

The detection method 140 concludes with outputting 143 marker data representative of the marker information determined by the second neural network. For example, the second neural network is configured to derive marker data from the image sub-portion including the ID marker. In examples where the ID marker comprises a text label, the second neural network may be configured to transcribe the image sub-portion including the label into label sequence data, e.g. marker data comprising a sequence (or “string”) of letters, digits, punctuation, or other characters. For the example sub-portion 122 shown in FIG. 12, the second neural network would output the marker data as label sequence data “AA-Z82” for the identification label of the picking station 50, for example. In alternative examples, the ID marker is a code, e.g. a QR (“Quick Response”) code or barcode, on the picking station, e.g. applied thereto on a label. The second neural network is configured, e.g. trained or learnt, to determine the code from the image of the ID marker on the picking station, for example. The code, e.g. marker data, can then be output. For example, the code may be further processed to decode the ID information encoded therein. In other words, the detected QR code or barcode is decoded to determine the ID information, e.g. name, of the picking station, for example.

In examples, the second neural network comprises a convolutional recurrent neural network (CRNN), configured to apply convolutions to extract visual features from the image sub-portion and arrange the features in a sequence. The CRNN comprises two neural networks, for example, a CNN and a further neural network. In some cases, the second neural network includes a bidirectional recurrent neural network (RNN), e.g. a bidirectional long-short term memory (LSTM) model. For example, the bidirectional RNN is configured to process the feature sequence output of the CNN to predict the ID sequence encoded in the marker, e.g. applying sequential clues learned from patterns in the feature sequences-such that the ID sequence is very likely to start with the letter “A” and end with a number in the example of FIG. 12. The second neural network may thus comprise a pipeline of more than one neural network, e.g. a CNN piped to a deep bidirectional LSTM such that the feature sequence output of the CNN is passed to the biLSTM which receives it as input. In other examples, the second neural network comprises a different type of deep learning architecture, e.g. deep neural network.

The previously described detection system may be configured to perform any of the detection methods described herein. For example, the detection system includes an image sensor to capture the images of at least part of the grid and an interface to obtain the image data. The detection system includes the trained object detection model, e.g. implemented on a graphics processing unit (GPU) or a specialised neural processing unit (NPU), to carry out the processing and determining steps of the computer-implemented method 140 of detecting an identification marker on a picking station 50.

The described systems and methods for detecting identification markers on picking stations 50 located on the grid 15 allow for the picking stations to be distinguished from one another, e.g. in a captured image of the grid 15 including multiple on-grid picking stations 50.

Furthermore, the automated detection of identification markers on the picking stations means that a camera 71 with a view of a selected pick station can be identified from a plurality of cameras 71 located above the grid 15, each with a different view 72 of the grid 15 and therefore different picking stations 50. For instance, if it were known that there is an issue with a particular picking station 50, the detection system could be used to find one or more camera 71 with the particular picking station 50 in its field of view such that a video feed from the said one or more camera 71 could be displayed to an operator. Such a system or method, for example, obtains ID information (e.g. an identifier) for a given picking station on the grid 15 and obtains a plurality of images of the grid 15 captured by respective cameras of a plurality of cameras mounted above the grid 15. The image data, representative of the plurality of images, is processed (e.g. as described above using first and second neural networks) to determine marker information associated with identification markers on the picking stations. The obtained ID information for the given picking station is compared with the determined marker information (e.g. a set of identifiers recognised on picking stations in the images) to determine one or more camera 71 with a view of the given picking station 50 on the grid 15, e.g. a field of view including at least part of the given picking station. In some examples where more than one camera 71 is identified as having a view of the given picking station 50, it may be determined which camera 71 has a field of view comprising the largest portion of the picking station 50—for example, the image feed of the camera 71 with the most of the picking station 50 in its field of view is selected for displaying to the operator. An operator viewing the images from the camera 71 can set one or more exclusion zones in the grid 15 to avoid collisions between transport devices 30 and the picking station 50, for example.

In some examples, it is determined which cameras 71 have which picking stations 50 in their field of view. For example, by recognising the marker information contained in the ID markers on the picking stations, the detection system can associate the marker information extracted from an image with the camera that captured the image. Thus, a record of which picking stations are viewable by which camera(s) can be determined and stored for future lookup.

In a further embodiment, the described detection of an identification (ID) marker on a picking station is done in response to the described detection of the (moving) picking station. For example, the image portion obtained as part of the ID detection method 140 may be determined based on the annotation data outputted as part of the detection method 130 for detecting moving picking stations, as described in examples above.

The above examples are to be understood as illustrative examples. Further examples are envisaged. For example, the cameras 71 disposed above the grid 15 have been described as ultra wide-angle cameras in many examples. However, the cameras 71 may be wide-angle cameras, which include a wide-angle lens having a relatively longer focal length than an ultra wide-angle lens, but still introduces distortion compared with a normal lens that reproduces a field of view which appears “natural” to a human observer.

Similarly, further techniques for the moving object detection, applied to a movable picking station, are envisaged. For example, a Canny edge detection algorithm may be combined with a multi-frame differential approach to obtain more complete information regarding the moving object. Alternatively, use of a combined version of a multi-image difference algorithm and background subtraction algorithm is envisaged to provide a more complete contour of the moving object.

Furthermore, in the described examples involving detecting an ID marker on a picking station, the image data is processed with a first neural network and a second neural network in succession. However, in alternative examples, the first and second neural networks are merged in an end-to-end ID marker detection pipeline or architecture, e.g. as a single neural network. For example, there is also provided a method of detecting an identification marker on a picking station on a grid comprising a plurality of grid cells, the grid forming part of a grid-based storage system in which one or more picking stations are mounted on the grid, each picking station comprising a robotic manipulator to transfer items between containers received in respective grid cells adjacent the picking station. The method comprises: obtaining image data representative of an image portion including a picking station of the one or more picking stations; processing the image data with at least one neural network trained to detect instances of identification markers on picking stations in images, and to recognise marker information, associated with identification markers, in images; and outputting marker data representative of the marker information determined by the at least one neural network. In the context of the detection system, according to this alternative example, the one or more processor is configured to implement at least one neural network trained to detect instances of identification markers on picking stations in images, and to recognise marker information, associated with identification markers, in images. The detection system is configured to process the obtained image data with the at least one neural network to generate marker data (e.g. a text string or code) representative of marker information (e.g. a descriptor of the picking station) present on (e.g. encoded in) an identification marker on the picking station, and output the marker data.

Additionally, in described examples regarding localisation of picking stations, the location of the detected picking station 50 on the grid 15 is determinable by comparing the annotation data indicating the detected picking station in the image with further annotation data corresponding to a plurality of virtual picking stations. In alternative examples, the location of a detected picking station 50 on the grid 15 can be determined in a two-step process. Firstly, the plurality of virtual picking stations are filtered, e.g. including calculating intersection over union (IoU) values using the prediction/inference data of the picking station 50 and the annotation data of the all possible locations of the plurality of virtual picking stations. For example, virtual picking stations with calculated IoU values smaller than a predetermined threshold are filtered out. Secondly, all remaining virtual picking stations are sorted (e.g. in ascending order) by a closest distance to a centre of the field of view of the camera, and the first (e.g. closest) virtual picking station is taken as a mapping. The grid location of the picking station 50 is then set to the grid location from which the annotation data of the mapped virtual picking station is created, for example.

A further embodiment is also envisaged in which a collision between a transport device 30 (e.g. bot) and a robotic picking station 50 is detected based on images captured by a camera with a view of the grid 15. For example, image data representative of a series of images (e.g. video data) of at least part of the grid is obtained and processed with an object detection model trained to detect instances of transport devices colliding with picking stations on the grid. It is determined, based on the processing, whether the series of images includes a transport device colliding with a picking station of the one or more picking stations. The object detection model comprises a neural network in examples, as described in general with reference to FIG. 9, which is taken to apply accordingly. For example, the object detection model is trained with a training set of videos of transport devices colliding with picking stations on the grid to classify videos subsequently captured by the cameras as including a collision or not. The image data may be obtained based on, e.g. in response to, a protective stop (or “p-stop”) alert from a given picking station 50 on the grid. For example, a protective stop may be initiated by the robot controller due to a fault being detected with the given robotic manipulator 52. Example causes of a protective stop include the given robotic manipulator 52 being overstressed, e.g. exceeding its operational specifications, and the robotic manipulator or its attached end-effector, peripheral or workpiece, coming into unexpected contact with (e.g. “bumping into”) something. Thus, in response to a p-stop being initiated by the robot controller, video data corresponding to a time period leading up to the p-stop may be obtained to determine whether a transport device collided with the robotic manipulator (thereby causing the p-stop warning to be issued).

In response to determining that the image includes a transport device colliding with a picking station, annotation data indicative of at least one of the transport device or the picking station in the image is generated and, in examples, outputted. In some cases, the method to recognise the identifier of the picking station is employed in response to the positive determination of the transport device colliding with the picking station. For example, the identifier information associated with the identifier on the picking station is determined and optionally output as part of the method. In some cases, an exclusion zone centred on the grid cell of the picking station is determined in response to determining that a transport device collided with the picking station. Additionally, or alternatively, an exclusion zone centred on the grid cell at which the crashed bot is located is determined. In some cases, the exclusion zone may be determined as a region of grid cells, e.g. a 3×3 cell area, centred on the grid cell. Thus, the exclusion zone may include a buffer area around the affected cell at which the crashed bot is located. In some cases, the crashed transport device spans more than one grid cell, e.g. where it is positioned between grid cells, has fallen over, or is misaligned with the grid 15. In such cases, the buffer area around the mapped grid cell can improve the effectiveness of the exclusion zone versus only excluding the mapped grid cell. The determined exclusion zone(s) can be implemented, e.g. by the master controller, to prohibit transport devices 30 entering the exclusion zone on the grid 15.

In examples employing storage to store data, the storage may be a random-access memory (RAM) such as DDR-SDRAM (double data rate synchronous dynamic random-access memory). In other examples, the storage 330 may include non-volatile memory such as Read-Only Memory (ROM) or a solid-state drive (SSD) such as Flash memory. The storage in some cases includes other storage media, e.g. magnetic, optical or tape media, a compact disc (CD), a digital versatile disc (DVD) or other data storage media. The storage may be removable or non-removable from the relevant system.

In examples employing data processing, a processor can be employed as part of the relevant system. The processor can be a general-purpose processor such as a central processing unit (CPU), a microprocessor, a graphics processing unit (GPU), a digital signal processor (DSP), an application-specific integrated circuit (ASIC), a field-programmable gate array (FPGA) or another programmable logic device, a discrete gate or transistor logic, discrete hardware components, or any suitable combination thereof designed to perform the data processing functions described herein.

In examples involving a neural network, a specialised processor may be employed as part of the relevant system. The specialised processor may be an NPU, a neural network accelerator (NNA) or other version of a hardware accelerator specialised for neural network functions. Additionally or alternatively, the neural network processing workload may be at least partly shared by one or more standard processors, e.g. CPU or GPU.

The term “annotation data” has been used throughout the description and is envisaged to correspond with prediction data or inference data in alternative nomenclature. For example, the object detection model (e.g. comprising a neural network) may be trained using annotated images, e.g. images with annotations such as bounding boxes, which serve as a ground truth for the model, e.g. a prediction or inference with a confidence of 100% or 1 when normalised. These annotations may be made by a human for the purposes of training the model, for example. Thus, the object detection of the present disclosure can be taken to involve outputting prediction data or inference data (e.g. instead of “annotation data”) to indicate a prediction or inference of the transport device in the image. The prediction data or inference data may be represented as an annotation applied to the image, e.g. a bounding box and/or a label. The prediction data or inference data includes a confidence associated with the prediction or inference of the transport device in the image, for example. The annotation can be applied to the image based on the generated prediction data or inference data, for example. For instance, the image may be updated to include a bounding box surrounding the predicted transport device with a label indicating the confidence level of the prediction, e.g. as a percentage value or a normalised value between 0 and 1.

It is also to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the accompanying claims.

1. A computer-implemented method of detecting a moving picking station on a grid comprising a plurality of grid cells, the grid forming part of a grid-based storage system in which one or more picking stations are mounted on the grid, each picking station comprising a robotic manipulator to transfer items between containers received in respective grid cells adjacent the picking station,
the method comprising:
obtaining image data representative of a series of images of at least part of the grid;
processing the image data with an object detection model trained to detect instances of picking stations on the grid;
determining, based on the processing, whether the series of images includes a moving picking station of the one or more picking stations; and
in response to determining that the image includes the moving picking station, outputting annotation data indicative of the moving picking station in the image.

2. A method according to claim 1, wherein the method comprises generating the annotation data.

3. A method according to claim 1, wherein the method comprises outputting an updated version of the image including the annotation data.

4. A method according to claim 1, wherein the annotation data comprises a bounding box.

5. A method according to claim 1, wherein the object detection model comprises a convolutional neural network.

6. A method according to claim 1, wherein determining whether the series of images includes a moving picking station comprises determining differences between multiple images of the series of images.

7. A method according to claim 6, wherein the differences are determined pixelwise.

8. A method according to claim 1, comprising:
determining a target image portion of a given image in the series of images based on the annotation data, wherein the target image portion comprises at least part of the moving picking station; and
mapping the target image portion to a target location on the grid; and
determining a location of the moving picking station on the grid based on the target location.

9. A method according to claim 1, wherein the object detection model is further trained to detect instances of picking stations that have a warning signal engaged, the method comprising:
processing the image data with the object detection model to determine, based on the processing, whether the image includes a picking station with the warning signal engaged.

10. A method according to claim 9, wherein the method comprises, in response to determining that the image includes the picking station with the warning signal engaged, outputting at least one of:
annotation data indicating a prediction of the picking station with the warning signal engaged in the image; or
an alert that the image includes the picking station with the warning signal engaged.

11. A data processing apparatus comprising means for carrying out the method of claim 1.

12-13. (canceled)

14. A detection system to detect a moving picking station on a grid comprising a plurality of grid cells, the grid forming part of a grid-based storage system in which one or more picking stations are mounted on the grid, each picking station comprising a robotic manipulator to transfer items between containers received in respective grid cells adjacent the picking station,
the detection system comprising:
an image sensor to capture a series of images of at least part of the grid;
an object detection model trained to detect instances of moving picking stations on the grid;
wherein the detection system is configured to:
obtain image data representative of the series of images;
process the image data with the object detection model;
determine, based on the processing, whether the series of images includes a moving picking station of the one or more picking stations; and
in response to determining that the image includes the moving picking station, output annotation data indicative of the moving picking station in the image.

15. A detection system according to claim 14, wherein the detection system includes a wide-angle or ultra wide-angle camera comprising the image sensor.
